(19) United States
(12) Patent Application Publication
(10) Pub. No.: US 2013/0091852 A1
(43) Pub. Date: Apr. 18, 2013

(54) OPERATING METHOD FOR HYDROGEN/NATURAL GAS BLENDS WITHIN A REHEAT GAS TURBINE

(71) Applicant: ALSTOM TECHNOLOGY LTD, Baden (CH)

(72) Inventors: John Philip Wood, Rütihof (CH); Madhavan Poyyapakkam, Rotkreuz (CH); Andrea Ciani, Zürich (CH); Khawar Syed, Oberrohrdorf (CH); Thierry Lachaux, Mellingen (CH); Franklin Marie Genin, Nussbaumen (CH); Adnan Eroglu, Untersiggenthal (CH)

(73) Assignee: ALSTOM TECHNOLOGY LTD, Baden (CH)

(21) Appl. No.: 13/649,502

(22) Filed: Oct. 11, 2012

Related U.S. Application Data
(60) Provisional application No. 61/546,321, filed on Oct. 12, 2011.

(51) Int. Cl. F02C 9/40

(52) U.S. Cl. 60/772; 60/734

(57) ABSTRACT

A gas turbine is operated using a varying blend of a first fuel, preferably natural gas, and a second fuel that is hydrogen. The hydrogen concentration is varied depending on operating conditions in order to reduce emissions of CO and NOx, and/or to mitigate LBO. The fuel mixture is varied using a controller based on a combination of factors in a modular operation concept to address different issues according to relevant load limitations. A method of operating a gas turbine according to this modular operational concept is also provided.

### INCORPORATION BY REFERENCE

The following documents are incorporated herein by reference as if fully set forth: U.S. Provisional Application No. 61/546,321, filed Oct. 12, 2011.

### FIELD OF INVENTION

The present invention relates to the field of combustion technology for gas turbines.

### BACKGROUND OF THE INVENTION

The investigation of hydrogen rich fuels has been ongoing for some time due to its significant environmental benefits. In particular two specific routes for hydrogen combustion have been widely investigated, these are:

1. Combustion of technically pure hydrogen (hydrogen diluted with inerts such that the hydrogen is the dominant volumetric species) in the context of pre-combustion carbon capture.

2. Combustion of synthetic gasses (hydrogen and carbon monoxide blends) derived from the gasification of biological material providing a carbon neutral fuel.

In both of these processes a fuel production facility would be used upstream of the gas turbine which would provide a continuous consistent supply of the fuel gas.

However, a new context for the provision of hydrogen has been proposed. This approach stems from the fact that many renewable energy sources are capable of generating consistent quantities of electricity regardless of the demand for power. This leads to potentially excess electricity at off peak times and the potential for having to reduce generating capacity and the inability to increase production at peak load. It has been previously proposed (and is not the subject of this disclosure) that excess power can be used at off-peak times to produce hydrogen by the electrolysis that can be burnt with no carbon emissions when required.

The obvious approach to utilize this fuel to provide peak power is through a gas turbine. As there are inefficiencies at each stage of the conversion process it is clear that the efficiency of the gas turbine must be maximized in order for the approach to be practical, which suggests the use of large scale combined cycle gas turbines. Such a unit would have a hydrogen consumption of approximately 6.5 kg/s at base load. It is consequently probable that insufficient hydrogen would be available for sustained base load operation. It should also be noted that many alternative energy sources provide inconsistent power outputs (e.g. wind or wave generators) that would cause the available quantity to vary with time. It is therefore probable that the proposed gas turbine would have to operate with a varying mix of natural gas and hydrogen.

In a reheat gas turbine two combustion systems based on significantly different physical processes are utilized. In the first system, fuel and air are premixed and a propagating flame is stabilized using carefully controlled aerodynamic structures. In the second combustion system vitiated air is mixed with the fuel. As the combustor inlet temperature is greater than the auto-ignition temperature of the fuel, combustion occurs after a characteristic delay time. As such, there is no need for complex aerodynamic flame stabilization devices as the flame will be self stabilizing at a predetermined location given by the flow velocity and the characteristic auto-ignition delay time.

Due to the different stabilization mechanisms in the two combustors the influence of using hydrogen within them differs. The aerodynamic stabilization used in the first combustor means the stability of this combustor can be influenced by changes in the burning velocity, which is strongly influenced by the fuel consumption and operating conditions. The auto-ignition delay time, the stabilizing factor in the reheat burner is also influenced by these parameters but as the axial location of the flame can alter within the combustor with limited impact on performance the potential exists to design a reheat combustion system that can tolerate a range of fuel compositions.

It is also possible to control the flame location through adjusting the inlet temperature of the vitiated air entering the reheat combustor through the impact this parameter has on the auto-ignition delay time. This is only achievable by reducing the flame temperature in the first combustion system; therefore the extent to which this can be achieved is limited by the flame stability in this burner.

Another characteristic of hydrogen fuel is that the auto-ignition delay time has a complex relationship with pressure initially falling as pressure is increased (in contrast to natural gas). This means that the use hydrogen poses particular challenges during starting the engine. It has been known to use up to 5% hydrogen for emissions and LBO (lean blow off) improvement

### SUMMARY

A gas turbine is operated using a varying blend of a first fuel, preferably natural gas, and a second fuel comprising hydrogen. The hydrogen concentration is varied depending on operating conditions in order to reduce emissions of CO and NOx, and/or to mitigate LBO. The fuel mixture is varied using a controller based on a combination of factors in a modular operation concept to address different issues according to relevant load limitations. A method of operating a gas turbine according to this modular operational concept is also provided.

In one aspect, a multi-stage gas turbine operating with a reheat cycle is used to burn a varying blend of natural gas and hydrogen, depending on the availability of hydrogen and operating conditions. Different concentrations of hydrogen can be utilized in the two combustion systems. The fuel used in the second combustor is enriched with the required concentration of hydrogen, with the appropriate flame position being achieved by adjusting the inlet temperature to the second combustor to improve LBO. As the required flame temperature of the first combustor is reduced, the stability range can be increased by the addition of a controlled amount of hydrogen to the fuel. Additionally NOx and CO emissions can be reduced.

In one aspect of the invention, up to 20% hydrogen is added to the natural gas fuel for reduced NOx emission at baseload conditions. The NOx reduction appears to be due to improvement in the mixing quality due to increased turbulence and diffusivity caused by the addition of hydrogen. There is also a prompt reduction due to the hydrogen addition. Further reductions can be indirectly achieved by operating at a lower stage 1 ratio.

In another aspect, up to 20% hydrogen is added to the natural gas fuel to reduce CO emissions at partial load conditions. This appears to be due to more reactivity of the fuel air mixture as well as possibly more OH radicals being generated for CO oxidation.

In another aspect, addition of 30% or more hydrogen is added to the natural gas fuel to improve LBO.

This can be used in connection with single as well as sequential combustors.

Further, the hydrogen can be added based on a combination of the above-noted factors in a modular operation concept to address different issues according to relevant load limitations. For example, higher hydrogen can be used at idle for LBO mitigation; intermediate hydrogen addition can be used at partial load conditions for CO and NOx emission reduction; and low hydrogen addition in combination with a decreased S1R (Stage 1 Ratio) can be utilized at baseload for low NOx emissions.

All such control actions are handled within the control system for the turbine based on the required and/or available hydrogen supply for the particular operating condition and objective.

### BRIEF DESCRIPTION OF THE DRAWINGS

The following detailed description of the preferred embodiment of the present invention will be better understood when read in conjunction with the appended drawings. For the purpose of illustrating the invention, there are shown in the drawings embodiments which are presently preferred. It is understood, however, that the invention is not limited to the precise arrangements and instrumentalities shown. In the drawings:

FIG. 1 is a schematic view of a turbine with sequential combustion chambers;

FIG. 2 is a pressure-ignition delay time graph at the inlet of the reheat combustor;

FIG. 3 is a graph showing LBO (lean blow off) versus hydrogen content for various S1R (stage 1 ratios—which is the S1 fuel gas mass flow to total gas mass flow ration);

FIG. 4 is a graph showing NOx emissions versus low S1R ratio for various hydrogen concentrations;

FIG. 5 is a graph showing NOx emissions versus high S1R ratio for various hydrogen concentrations;

FIG. 6 is a graph showing CO emissions versus low S1R ratio for various hydrogen concentrations;

FIG. 7 is a graph showing CO emissions versus high S1R ratio for various hydrogen concentrations;

FIG. 8 is a graph showing Zeta versus hydrogen content for various S1R ratios in a lower region;

FIG. 9 is a graph showing Zeta versus hydrogen content for various S1R ratios in a higher region;

FIG. 10 is a diagram of a single stage gas turbine operating with a blend of natural gas and hydrogen that is controlled depending on hydrogen availability and/or operating conditions; and

FIG. 11 is a diagram of a multi-stage gas turbine operating with a reheat cycle to burn a blend of natural gas and hydrogen that is controlled depending on hydrogen availability and/or operating conditions.

### DETAILED DESCRIPTION OF THE PREFERRED EMBODIMENTS

The disclosure deals with current and future capability to burn hydrogen enriched natural gas as a means of utilizing excess renewable generating capacity during off-peak periods. It relates to an operating method for the operation of an industrial gas turbine with a hydrogen enriched natural gas fuel and/or a diluted hydrogen fuel.

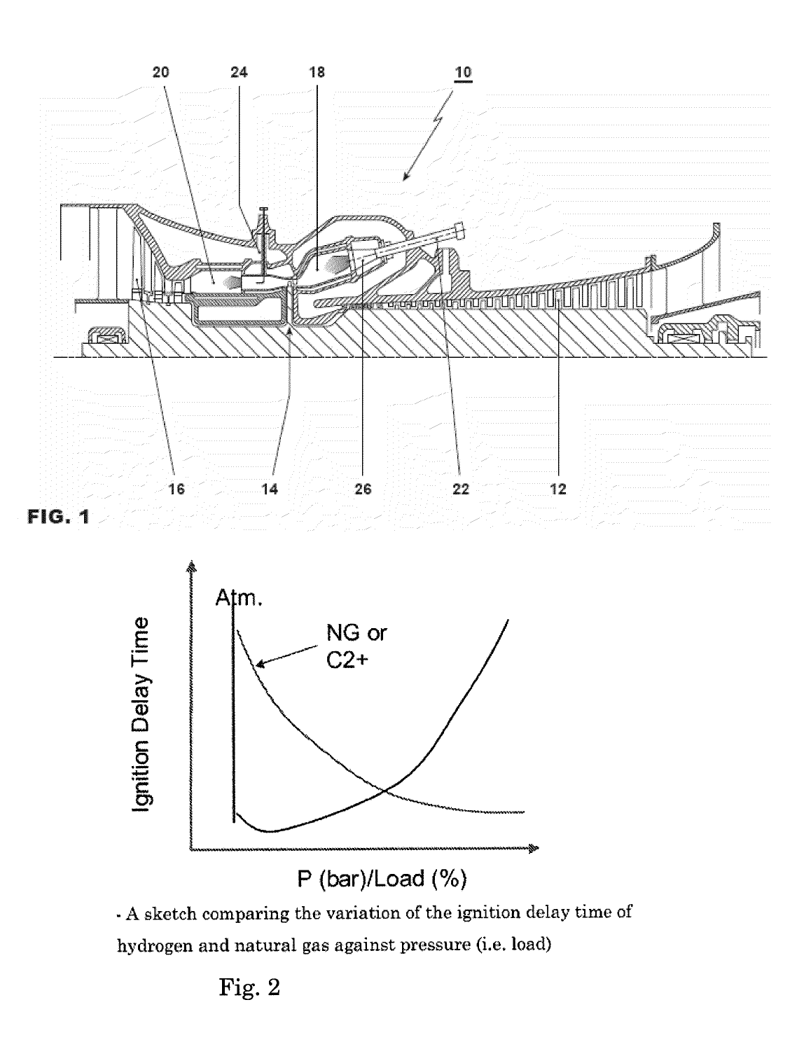

FIG. 1 shows a reheat gas turbine 10 with a compressor 12, high pressure and low pressure output turbine blade sections or stages 14, 16, and first and second annular combustors 18, 20. Fuel is injected into the combustors 18, 20 with fuel lances 22, 24, for the respective chambers 18, 20. The fuel is preferably a controlled mix of natural gas and hydrogen. As shown schematically in FIG. 11, the fuel is blended in fuel blending systems 30, 30′, preferably mixing chambers, associated with each turbine stage in which varying amounts of natural gas and hydrogen are mixed depending on operating conditions and/or the availability of hydrogen required for one or both combustors 18, 20. The mixture is controlled by a controller 32, which can be a programmable logic controller (plc) or computer based controller that controls servo valves 34, 34′ for natural gas for each turbine stage and servo valves 36, 36′ for hydrogen. The fuel is fed to either or both of the combustors 18, 20, shown in FIGS. 1 and 11. Burners 26 are provided to ignite the fuel/compressed air mixture in the first annular combustor 18, while the second (reheat) combustor 20 receives hot gases from the first combustor 18 at a high enough temperature to auto-ignite the additional fuel. Separate fuel blending systems 30, 30′ allow the combustors 18, 20 to receive different blends.

The operating method for a turbine 10 provides different stabilization mechanisms utilized within the two stage combustion system of a reheat gas turbine 10, flexibility inherent in a reheat turbine as to which point in the operating cycle the reheat burner operates, and hydrogen to increase fuel reactivity, and hence burner stability, when operating the reheat combustor 20 at low inlet temperatures or part load.

The reactivity of hydrogen fuel at temperatures characteristic of the inlet of a reheat combustor decreases with increasing pressure (i.e. load) as shown in FIG. 2. This is opposite to the trend of natural gas. This behavior of hydrogen reactivity causes a significant difficulty in the design of reheat combustion hardware, as it is impossible to optimize both for base load operation and run-up safety. For this reason it proposed that the turbine 10 is started on natural gas with hydrogen only being introduced to the reheat combustor 20 when a threshold pressure (i.e. load) has been exceeded.

For any fuel the time required for spontaneous ignition is strongly related to the temperature of the reactants. For this reason if, in a reheat combustor 20, highly reactive fuels need to be utilized this often requires the reduction of the inlet temperature of the hot gas. In general the gas turbine is operated in such a way that the vitiated air at the injection plane is maintained at a specific temperature defined in the control algorithm.

Here, instead of being fixed the temperature set point defined in the control program is adjusted in real time to accommodate changes in the reactivity of the fuel (driven by fuel composition changes). Such changes would be handled automatically by the controller 32 by using suitable operating maps defining an appropriate inlet temperature for a given composition. The fuel composition can be identified either by real time monitoring of a time varying fuel with an instrument such as a gas chromatograph. Alternatively where the fuel is blended from two or more sources the output from flow meters in the individual streams may be monitored to determine the composition at inlet to the burner.

In most premixed burners, flame stabilization is achieved by introducing complex aerodynamic structures that balance the speed at which the flame front attempts to propagate into the premixed reactants. For this reason it is possible to cause the flame to stabilize in free space. The speed at which the flame propagates is a function, among other parameters, of the composition of the reactants, and in particular the fuel type and oxidant concentration. It is thus possible to produce an operating point (whether by the choice of fuel, or by limiting the oxidant availability (e.g. flue gas recirculation), or by alternate means) where a significant imbalance exists between the velocity in the flow field and the propagation speed of the flame, such that the flame velocity is lower than the flow velocity. In this situation the flame will cease to be stable and be extinguished.

Due to the high flame propagation speed of hydrogen, the controller 32 allows such flame instabilities to be avoided by adding an appropriate concentration of hydrogen to the fuel. Here, at operating conditions under which flame stability is an issue, hydrogen is added to the fuel flow to restore stability. It is further provided that the amount of hydrogen to be added can be identified automatically by an engine control algorithm based on suitable maps identifying the required hydrogen to stabilize the operating point.

The gas turbine 10 can be started on natural gas using the first stage combustor 18. The engine would run up to an operating point (approximately 6 to 8 bar) at which the increased reactivity of hydrogen at lower pressures is no longer apparent prior to the starting of the reheat combustion system.

The proportion of hydrogen in the fuel for the reheat combustor 20 is selected automatically by the controller 32. A wide range of differing hydrogen compositions can be accommodated by automatically applying a map of reheat burner inlet temperature against hydrogen composition, i.e. if a high hydrogen concentration is required this can be accommodated by de-rating the inlet temperature.

As the inlet temperature of the reheat combustor 20 is reduced, the potential for stability issues within the first stage combustor 18 could become apparent. This can be resolved by the controller 32 adding a small proportion of hydrogen, again based on an automatic operational map, to the primary combustor 18 to increase reactivity and hence extend the proportion of hydrogen that can be accommodated.

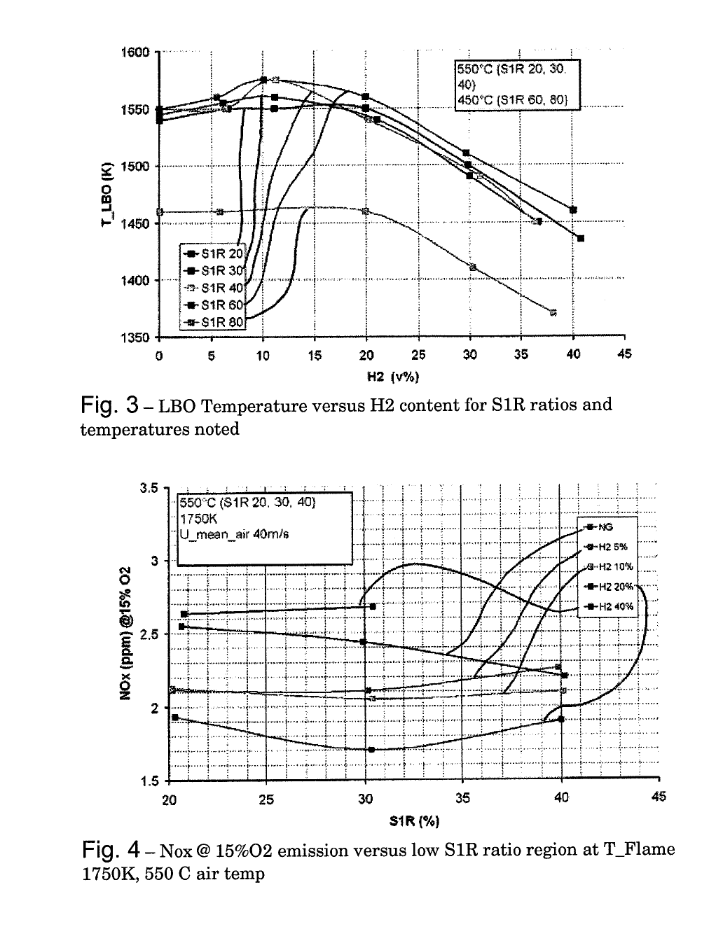

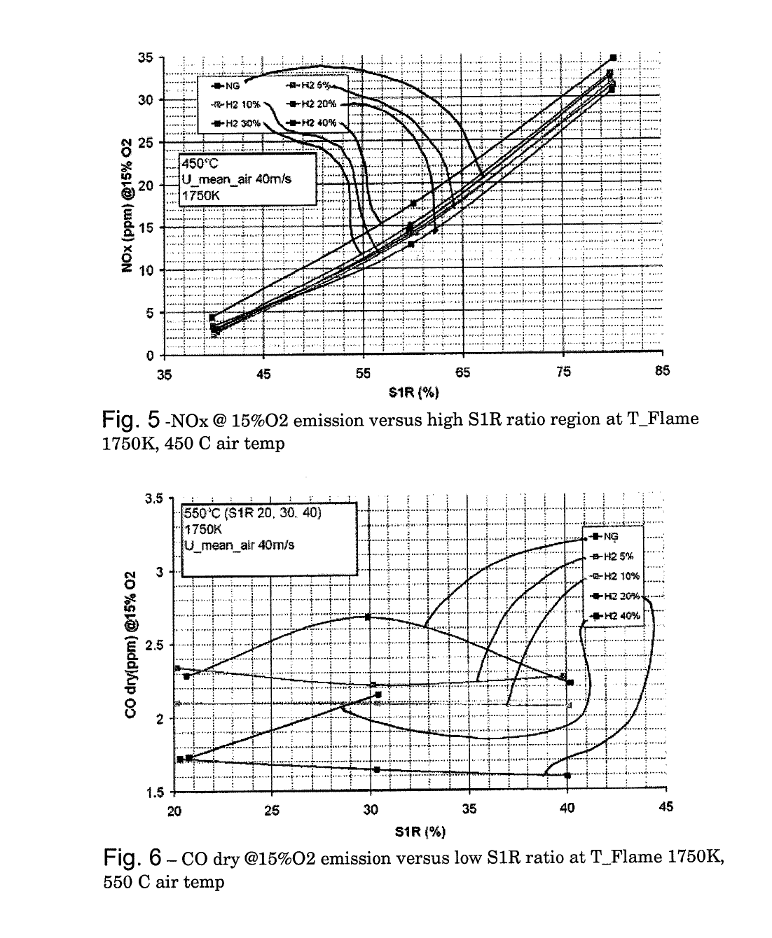

The controller 32 can also control the amount of hydrogen being added in order to control LBO. As shown in FIG. 3, the addition of hydrogen of about 20% or more of the fuel volume improves LBO. FIGS. 4 and 5 show that there is a significant reduction in NOx emissions for hydrogen content of up to 20%. A further improvement can be obtained in NOx emissions by operating with a lower S1R (stage 1 ratio=fuel gas mass flow/total gas mass flow) than in a turbine running on natural gas alone.

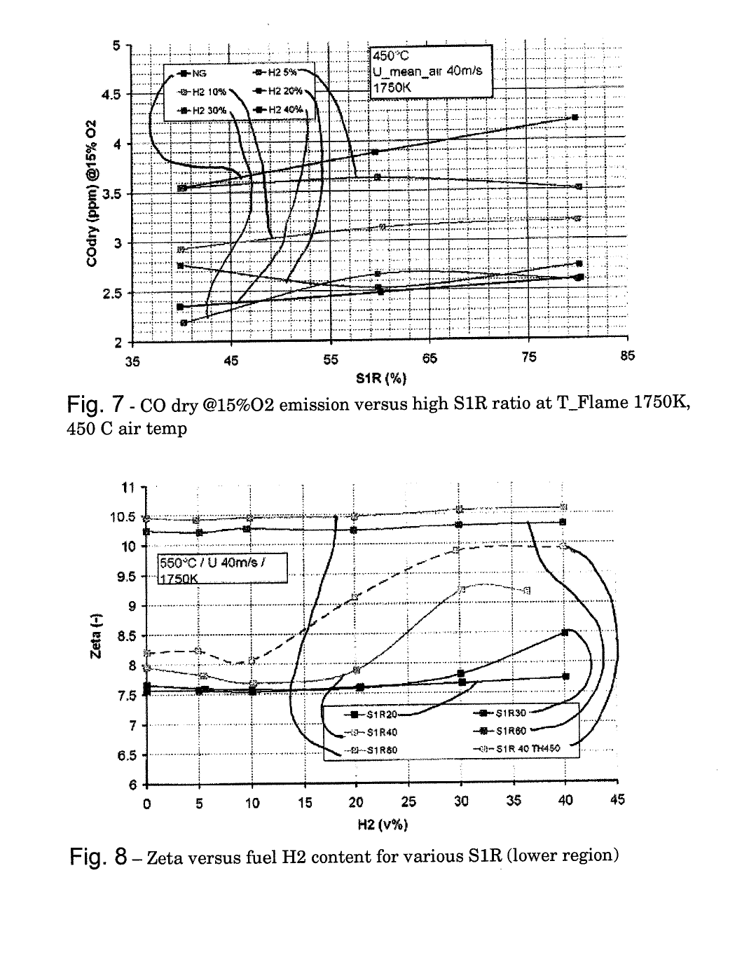

The controller 32 can also be used to lower CO emissions by the addition of hydrogen preferably in the 20% to 40% range, as shown in FIGS. 6 and 7. This is believed to be due to increased fuel reactivity and OH radical formation. This effect is important at high pressures.

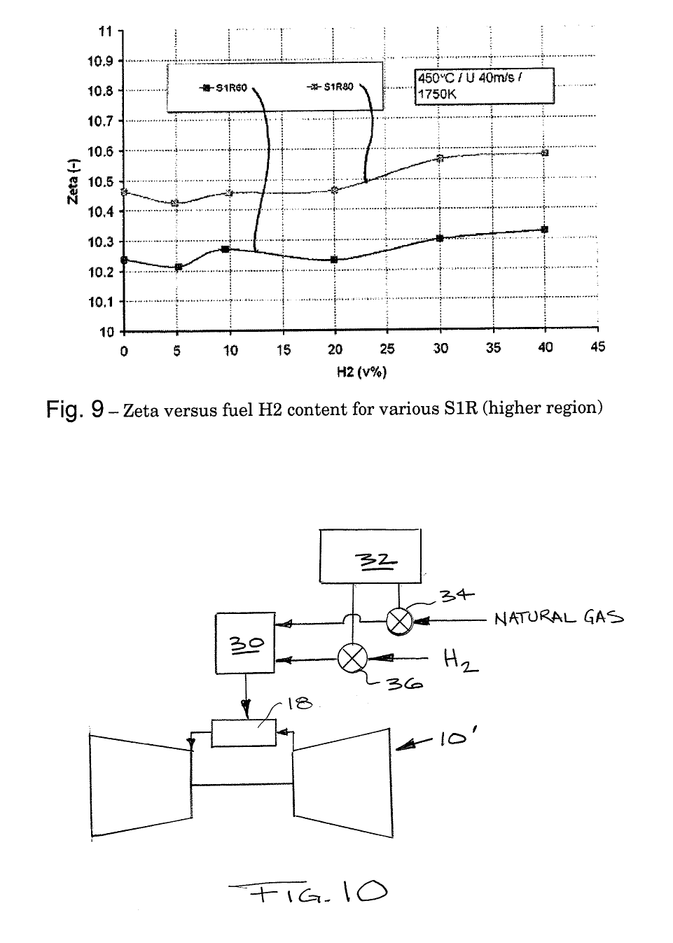

FIGS. 8 and 9 show that pressure drop (zeta) is stable for hydrogen up to about 20%. Above 20% a modest increase in zeta is observed.

Based on this, the controller 32 can operate to optimize certain performance characteristics depending on operating conditions. Hydrogen is preferably added to the fuel mixture to about 20% for the baseload condition to improve emissions of NOx and CO. At part load conditions, 20% hydrogen is added to the fuel mixture to continue to reduce CO emissions. 30% or more hydrogen can be added to the fuel mix to improve LBO conditions, with some sacrifice in other areas. As previously noted, the addition of the hydrogen to the fuel mix can be used in both single or reheat combustors. For reheat combustors 20, the hydrogen addition to the fuel mix can be controlled separately for the first and second stage combustors 18, 20. The controller 32 preferably utilizes a modular operation concept so that the controlled addition of hydrogen is done at different times to address different issues, with higher hydrogen (30% or more) addition at idle for LBO mitigation, intermediate hydrogen addition (10% to 30%) at part load to improve CO and NOx emissions, and low hydrogen addition and a decreased S1R at baseload for low NOx. This fuel modulation generally does not affect pressure drop, so no impact on engine performance is anticipated.

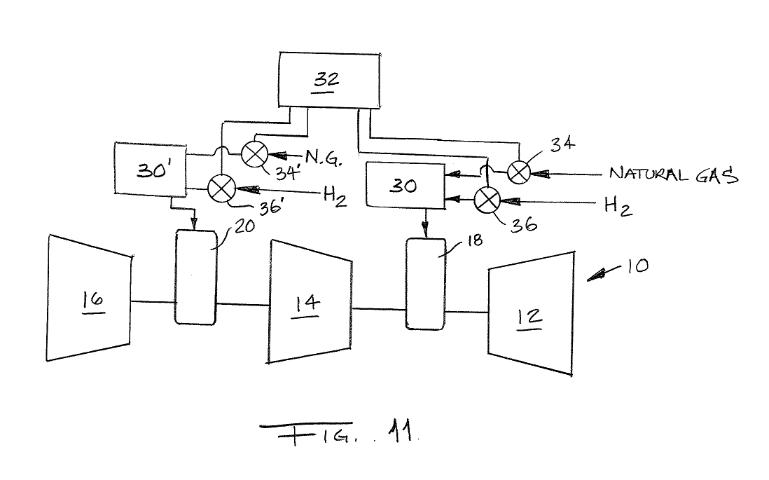

FIG. 10 shows a single stage turbine 10′ with only a single fuel blending system 30 as discussed above that is controlled by the controller 32 in order to reduce emissions or optimize performance using a fuel mixture of natural gas and hydrogen. The components that are functionally the same as for the reheat turbine 10 are indicated with the same reference numerals.

It is understood, therefore, that this invention is not limited to the particular embodiments disclosed, but is intended to cover all modifications which are within the spirit and scope of the invention as defined by the appended claims; the above description; and/or shown in the attached drawings.

### REFERENCE NUMERALS

10 gas turbine
12 compressor
14 high pressure stage
16 low pressure stage
18, 20 combustor
22, 24 fuel lance
26 burner
30, 30′ blending system
32 controller
34, 34′ servo valve (natural gas)
36, 36′ servo valve (hydrogen)

What is claimed is:

1. A method for operating a gas turbine comprising:
starting up the turbine using a first fuel;
adding a second fuel to the first fuel during operation of the gas turbine to create a fuel mix, wherein the second fuel comprises hydrogen; and
using a controller to vary an amount of hydrogen added to the first fuel during operation in order to reduce at least one of NOx emissions or CO emissions.

2. The method of claim 1, wherein the gas turbine is a reheat gas turbine with a high pressure turbine and a low pressure turbine, and the controller adds at least 30% hydrogen to the fuel mix at idle to improve lean blow off (LBO).

3. The method of claim 1, wherein the gas turbine is a reheat gas turbine with a high pressure turbine and a low pressure turbine, and the controller adds between 10% to 30% hydrogen to the fuel mix to improve emissions of NOx and CO.

4. The method of claim 1, wherein the gas turbine is a reheat gas turbine with a high pressure stage and a low pressure stage, and the controller adds about 10% hydrogen to the fuel mix at baseload to reduce NOx emissions.

5. The method of claim 4, wherein the controller reduces a ratio of fuel gas mass flow/total gas mass flow in the high pressure stage.

6. The method of claim 1, wherein the gas turbine is a reheat gas turbine with a high pressure turbine and a low pressure turbine, and the controller controls a first fuel blending system that supplies the fuel mix to a combustor for the high pressure turbine, and the controller controls a second fuel blending system that supplies a second fuel mix to a combustor for the low pressure turbine, and the first and second fuel mixes can be the same or different.

7. The method of claim 1, wherein the controller controls a fuel blending system that supplies the fuel mix to a combustor for the gas turbine.

8. A method for operating a gas turbine comprising:
starting up the turbine using a first fuel;
running the turbine to a preselected operating point;
adding a second fuel to the first fuel during operation of the gas turbine to create a fuel mix, wherein the second fuel comprises hydrogen; and
using a controller to vary an amount of hydrogen added to the first fuel during operation in order to reduce at least one of NOx emissions or CO emissions.

9. The method of claim 8, wherein the preselected operating point is a pressure of 6-8 bar.

10. The method of claim 8, wherein the gas turbine is a reheat gas turbine with a high pressure turbine and a low pressure turbine, and the controller adds at least 30% hydrogen to the fuel mix at idle to improve lean blow off (LBO).

11. The method of claim 10, wherein the controller selects the amount of hydrogen to add to the first fuel based on a reheat burner inlet temperature in view of a hydrogen composition.

12. A multi-stage gas turbine comprising a compressor, a first combustor in communication therewith, a first output turbine blade section, downstream of the first combustor and upstream of a second combustor in communication with a second output turbine blade section, the gas turbine further comprising first and second fuel supply valves, which provide fuel to first and second fuel blending systems, the first and second fuel blending systems are in communication with and provide first and second fuels to the first and second combustors, the first and second fuel supply valves are in communication with and are controlled by a controller.

13. The gas turbine of claim 12, wherein the first output turbine blade section is a high pressure turbine and the second output turbine blade section is a low pressure turbine.

14. The gas turbine of claim 12, wherein the first and second fuel supply valves are servo valves.

15. The gas turbine of claim 12, wherein the controller is a programmable logic controller or a computer-based controller.

16. The gas turbine of claim 12, wherein the first and second fuel blending systems operate independently of one another.
